(19) United States
(12) Patent Application Publication
(10) Pub. No.: US 2002/0138960 A1
(43) Pub. Date: Oct. 3, 2002

(54) Marine vessel memento and method of preparing same

(76) Inventor: K. Wayne Elliott, Port Colborne (CA)

Correspondence Address: ECKERT SEAMANS CHERIN & MELLOTT, 600 GRANT STREET, 44TH FLOOR, PITTSBURGH, PA, 15219

(21) Appl. No.: 09/822,885

(22) Filed: Mar. 30, 2001

(51) Int. Cl. B23P 11/00

(52) U.S. Cl. 29/428

(57) ABSTRACT

Pieces are cut from the plating of a ship, submarine, or other marine vessel and provided with information, such as a depiction of the vessel, in order to create a memento of the vessel. The information may be inscribed into the piece or a plate with the information may be attached to the piece.

### BACKGROUND OF THE INVENTION

This invention relates to a marine vessel memento and a method of preparing same.

Larger marine vessels may develop a significant reputation amongst segments of the population. A vessel may be remembered by those who have served as its crew, their families, passengers, and other who depend upon the vessel. Further, some vessels—as, for example, the aircraft carrier the USS Enterprise—are broadly known and excite the imagination of many.

An individual with an affinity for a vessel may retain a picture of the vessel or possibly a scale model or other keepsake. This, however, may be a poor reflection of the bond the individual may have with the vessel.

This invention seeks to provide an improved memento of a marine vessel.

### SUMMARY OF THE INVENTION

Pieces are cut from the plating of a ship, submarine, or other marine vessel and provided with information, such as a depiction of the vessel, in order to create a memento of the vessel.

Accordingly, the present invention provides a method of preparing a memento of a marine vessel, comprising: cutting pieces from the plating of the vessel and providing each piece with information concerning the vessel.

According to another aspect, the invention provides a piece of metal plate cut from a marine vessel bearing information concerning the vessel.

### BRIEF DESCRIPTION OF THE DRAWINGS

In the drawings which illustrate example embodiments of the invention,

FIG. 1 schematically illustrates methods used in preparing a memento in accordance with this invention, and

FIGS. 2a and 2b schematically illustrate mementos prepared in accordance with this invention.

### DETAILED DESCRIPTION

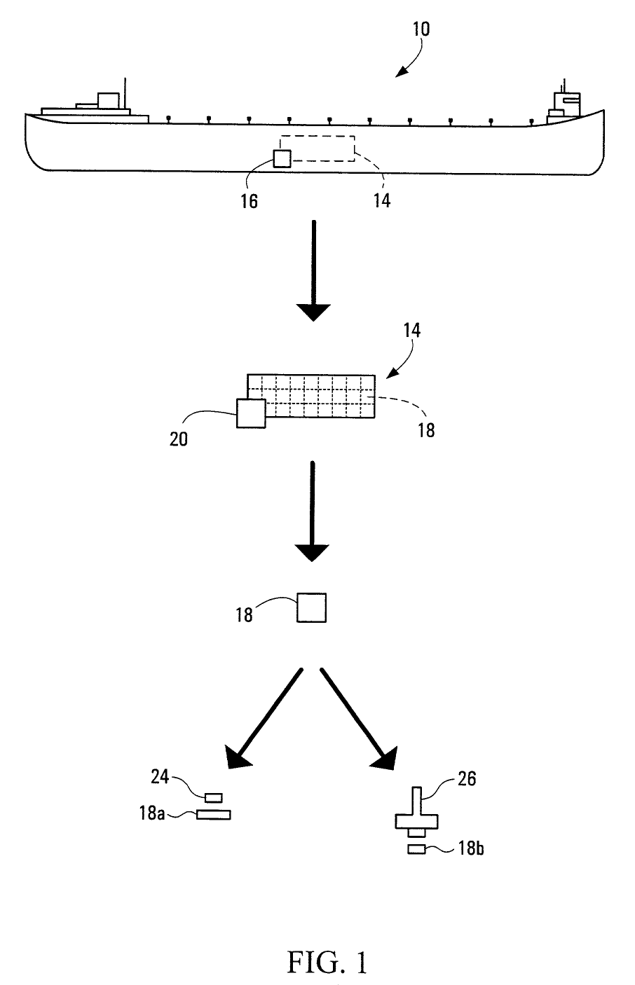

Turning to FIG. 1, after a marine vessel 10 is taken out of service, mementoes of the vessel may be prepared, as follows. Firstly, sections 14 are cut from the plating of the vessel by a cutter 16. The plating could be from the hull, decking, superstructure, tank plate, tank tops, tank floors, bulkheads, internals, hatch plates, hatch plate covers, or arches of the vessel. These sections 14 are normally metal plate and may be cut from the plating of the vessel with an oxygen/propane or oxygen/acetylene torch. Conveniently, the sections are on the order of eight feet wide by twenty feet long. They may be of various thicknesses, but often will have a thickness of 3/16″ to ⅜″. Manufacture is facilitated if the sections 14 are of a uniform thickness. Any structural stiffeners are cut from the removed sections 14.

Next, the sections are cut into pieces 18 by a cutter 20. The cutter may be, for example, a laser. The pieces 18 may be square or rectangular. An exemplary suitable size for the pieces is 2 ¼″ square.

After the pieces are cut, they may be provided with information concerning the vessel 10. For example, a plate 24 bearing information concerning the vessel may be attached to a piece 18a in any suitable manner, such as with tape or glue. The attached plate could, for example, be brass. Alternatively, pieces 18b may be inscribed with information by a stamp 26 or with an acid etch.

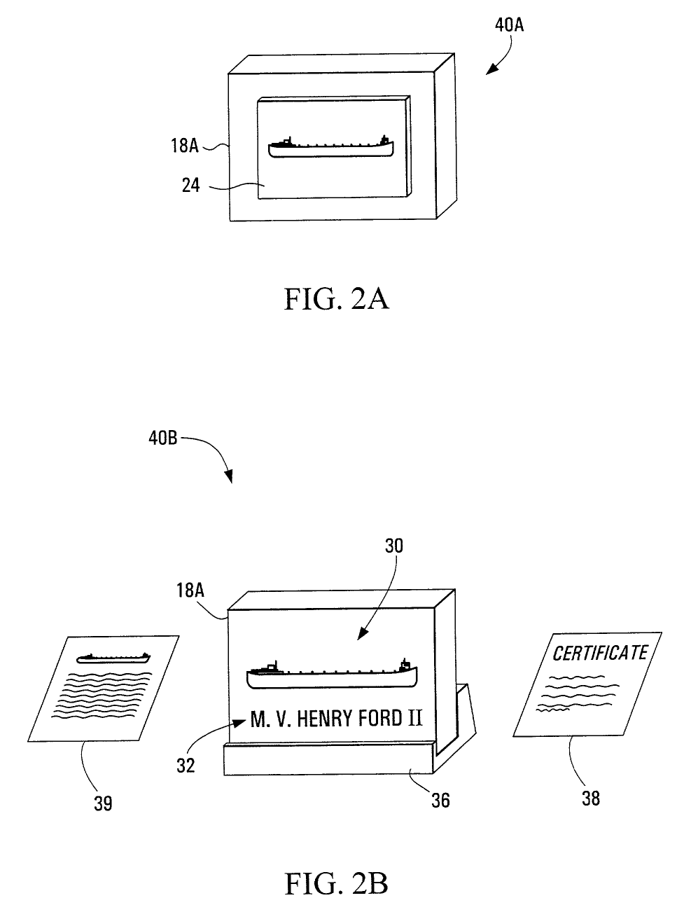

The information provided on the piece 18a, 18b may comprise a depiction 30 (FIG. 2b) of the vessel 10 (FIG. 1) and/or the name 32 (FIG. 2b) of the vessel. Additionally, or alternatively, the information may comprise statistics relating to the vessel such as its build date, demolition date, hull number, official number, and tonnage.

Optionally, the piece 18 may be painted.

A piece 18, provisioned with information concerning the vessel, may comprise a completed memento, as illustrated, for example, by the memento 40a shown in FIG. 2a.

Alternatively, turning to FIG. 2b, a piece 18, provisioned with information, may be set into a holder 36. The piece may be attached to holder 36 or may simply rest in the holder. A certificate of authenticity 38 may also be associated with the piece. As well, a sheet 39 (or other element) which depicts the vessel and sets out a facts relating to it may also be associated with the piece. The piece within the holder, certificate, and sheet comprise a composite memento 40b.

Mementos of marine vessels of a given type (e.g., U.S. warships, Canadian freighters, etc.) may be sold as a collectors series. For a vessel which is part of a collectors series, it may be preferred to prepare a limited number of mementos and provide each such memento with a unique number. In respect of composite memento 40b, this is conveniently done by numbering the certificate of authenticity 38 associated with the composite memento.

Mementoes, as described, may be prepared from ships, such as warships, freighters, cruise liners, and ferries. They may also be prepared from submarines. While the teachings of this invention are also applicable to small watercraft and barges, such vessels generally have an insufficient reputation to warrant the expense of preparing the described mementoes.

Modifications will be apparent to those skilled in the art and, therefore, the invention is defined in the claims.

What is claimed is:

1. A method of preparing a memento of a marine vessel, comprising:
cutting pieces from plating of said vessel; and
providing each piece with information concerning said vessel.

2. The method of claim 1 wherein each piece is a piece of metal plate.

3. The method of claim 1 wherein said information comprises a depiction of said vessel.

4. The method of claim 1 wherein said information comprises a name of said vessel.

5. The method of claim 4 wherein said information further comprises statistics relating to said vessel.

6. The method of claim 1 wherein said providing comprises attaching a plate bearing said information onto said each piece.

7. The method of claim 1 wherein said providing comprises inscribing said information in said each piece.

8. The method of claim 7 wherein said inscribing comprises stamping.

9. The method of claim 7 wherein said inscribing comprises etching.

10. The method of claim 9 wherein said etching comprises acid etching.

11. The method of claim 1 wherein said marine vessel is a ship.

12. The method of claim 11 wherein said marine vessel is a warship.

13. The method of claim 1 wherein said cutting pieces comprises cutting sections from plating of said vessel and cutting said pieces from said sections.

14. The method of claim 13 wherein said sections are cut with a torch.

15. The method of claim 14 wherein said pieces are cut with a laser from said sections.

16. The method of claim 1 further comprising setting said each piece into a holder.

17. The method of claim 1 further comprising associating a certificate with said each piece.

18. The method of claim 1 further comprising associating an element with said each piece, said element bearing at least a depiction of said vessel.

19. The method of claim 2 wherein said cutting comprises cutting sections from said vessel and cutting said pieces from said sections and wherein said information comprises a depiction of said vessel.

20. The method of claim 19 wherein said information further comprises a name of said vessel and statistics relating to said vessel.

21. The method of claim 20 wherein said providing information comprises etching said pieces.

22. The method of claim 1 wherein said plating of said vessel is cut from one of the hull, decking, superstructure, tank plate, tank tops, tank floors, bulkheads, internals, hatch plates, hatch plate covers, or arches of said vessel.

23. A piece of metal plate cut from a marine vessel bearing information concerning said vessel.

24. The piece of metal plate of claim 22 wherein said information comprises a depiction of said marine vessel.
